(19) United States
(12) Patent Application Publication
(10) Pub. No.: US 2006/0111943 A1
(43) Pub. Date: May 25, 2006

(54) Method and system to edit and analyze longitudinal personal health data using a web-based application

(76) Inventor: Harry C. Wu, Concord, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/274,053

(22) Filed: Nov. 14, 2005

Related U.S. Application Data
(60) Provisional application No. 60/627,924, filed on Nov. 15, 2004.

(51) Int. Cl. G06Q 10/00

(52) U.S. Cl. 705/3; 705/2

(57) ABSTRACT

In a global computer network, a system for processing personal health records is disclosed. The system includes a web-based application providing an application web server that does not store personal data. A user starts a new session using the application web site and begins entering medical data. During the session, with the user's data in transient storage, the application web site can perform health risk assessments and search other databases to provide information relevant to the user's health. At the end of the session, the user downloads a file that saves all of the data. Next, the application web site erases the user's data from the web site. The user continues data entry in the future by uploading the saved file. Since the user keeps the data, no identification of the user is necessary and privacy is preserved.

### RELATED APPLICATION(S)

This application claims the benefit of U.S. Provisional Application No. 60/627,924, filed on Nov. 15, 2004. The entire teachings of the above application is incorporated herein by reference.

### BACKGROUND OF THE INVENTION

One of the major problems in the healthcare industry is that personal medical data records are not properly accessible for later review. As a result, doctors may not have all the necessary information to treat patients in an effective manner which in turn, may increase medical errors. Similarly, patients may encounter the same problems when reviewing their own personal medical data records in that records may be missing. A missing record could be potentially fatal in some circumstances.

Recognizing this problem, the U.S. government desires that the healthcare industry use electronic health records/electronic medical records; however there are many factors to consider before transitioning to such a system. These factors include financial, i.e., who will pay for these changes; technical, i.e., how to integrate all the different types of medical systems without incompatibility issues; social, i.e., the public willingness of others having access to private medical data such as sexually transmitted diseases; and regulatory, i.e., ensuring compliance with privacy laws and the regulations against sharing medical data.

Today, a medical visit has the potential for many errors due to a doctor being misinformed. For example, on a typical visit to the doctor, the doctor may ask about a person's health history. That is, the doctor will ask questions such as, “What are your current health conditions?, Are you a smoker?, or Do you exercise regularly?”. These types of questions can be answered by most everyone. However, after this initial line of questioning, a doctor will begin to ask open ended questions such as, “Do you have allergies?”. Here is where the problem lies as even if a person knows all his/her allergic conditions, the person may inadvertently omit or forget an allergy. Therefore, there is a need to have all this pertinent medical information on paper and, in turn, for the patient to bring this piece of paper with him for a medical visit.

The paper solution is prevalent in the health care industry with the use of 3-ring medical record binders having special forms for organizing and storing the medical data. This solution has some merits, but requires the user to diligently maintain the binders and tolerate the bulky nature of a binder. Further, keeping medical information on paper is subject to being lost. To combat the problem of storing information on paper, the industry has started to use software packages that provide similar capabilities and features as the binder/form products. This software solution is better than the three-ring binders but still has flaws. Specifically, the software is subject to problems with installation, maintenance and upgrades. Further, the data would reside in an isolated storage area such as the home PC, thus losing portability.

Accordingly, there are a few products that provide a web-based solution or electronic personal health record (EPHR) on the web (see, for example, mynetrecord, capmed). In fact, a recent survey indicated that 50% of people would use an electronic product. However, the industry has no convenient way to store medical health data electronically in a single location with proper security precautions. Therefore, there is a need for an electronic medical information system that solves the public's concern about storing personal medical data in a single location securely.

### SUMMARY OF THE INVENTION

A method to edit and analyze personal health data is achieved by a web-based application that stores data temporarily at a web site while the data is being edited and analyzed. At the end of the editing and analysis session, the data is optionally transferred to a permanent storage location external to an application web server. Upon return to the application web site, the data is uploaded for use in subsequent sessions. At the end of each session, the data is erased from the application web site's internal storage.

In one embodiment of the present invention, an electronic medical information system is used for storing and analyzing data. This electronic medical information system has a server containing a data storage area and a knowledge base. The data storage area is used for temporarily storing one or more patient medical records anonymously and for a given patient, providing a single location for access to all medical records of that patient. In addition to the storage and access capabilities, the data storage area maintains the data in a secure manner. The user may in a secure manner use the server to access the data storage area along with a knowledge base in order to determine relevant medical history or advice.

In another embodiment of the present invention, data in general is temporarily received by the data storage area from a user upload or a third party site connection. The data storage area is capable of storing a specific type of data known as longitudinal data. That is, data itself can be stored in a longitudinal manner which refers to data items that may possess different values over time.

In yet another embodiment of the present invention, the user is different types of people who can execute the same tasks on the electronic medical system. The user can be a person in the medical field and uses the server for accessing the data storage area in such a way as to retrieve one or more patient medical records. On the other hand, the user is a patient and uses the server for accessing the data storage area in such a way as to retrieve one or more of his medical records. The user may use the server to search the contents of one or more patient records, enter data, manually, into one or more patient medical records, or download the one or more patient medical files to a local computer. Further, the user may configure the server to receive a reminder relating to one or more patient medical records. Finally, the user may import one or more patient medical records of a relative so as to create a family medical history where the family medical history is accessible to the knowledge base for analysis.

In still yet another embodiment of the present invention, the server can provide a user with the appropriate medical information. For example, the server can provide the user with a report based on one or more patient records or provide the user an ability to schedule one or more medical occurrences with a calendar for analysis and allows the user to analyze the calendar for an episodic summarization. In addition, the server may analyze the data in one or more patient medical records using the knowledge base. Alternatively, the user could receive consultation recommendations based on a set of rules within the knowledge base. Using the set of rules, the knowledge base is capable of validating data entered by the user, analyzing the one or more patient medical records for health risks, formulating search strategies to gather relevant information and analyzing digital files to detect abnormalities.

The foregoing and other features and advantages of the system and method to edit and analyze longitudinal personal medical data will be apparent from the following more particular description of preferred embodiments as illustrated in the accompanying drawings. It is to be expressly understood, however, that each of the drawings is given for the purpose of illustration only and is not intended as a definition of the limits of the present invention.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram that illustrates the operating environment of a preferred embodiment that assists users in entering, analyzing, reporting and storing of longitudinal medical data, such as personal health history, using a web site in accordance with the present invention;

FIG. 2 is a block diagram that illustrates system level operation and interoperation in a preferred embodiment of the present invention;

FIG. 3 is a flow chart that illustrates a user session in accordance with a preferred embodiment of the present invention;

FIG. 4 is a block diagram that illustrates a menu of user commands in accordance with a preferred embodiment of the present invention;

FIG. 5 is a flow chart that illustrates the data (text and binary) export process in accordance with a preferred embodiment of the present invention;

FIG. 6 is a flow chart that illustrates the data (text and binary) import process in accordance with a preferred embodiment of the present invention;

FIG. 7 is a flow chart that illustrates the report generation process in accordance with a preferred embodiment of the present invention;

FIG. 8 is a flow chart that illustrates the data analysis process in accordance with a preferred embodiment of the present invention;

FIG. 9 is a flow chart that illustrates the reminder process in accordance with a preferred embodiment of the present invention;

FIG. 10 is a flow chart that illustrates the search process in accordance with a preferred embodiment of the present invention;

FIG. 11a to FIG. 11i are screen captures that illustrate data entry forms that organize and group data elements based on relatedness in accordance with a preferred embodiment of the present invention;

FIG. 12a to FIG. 12c are screen captures that show examples of reports that may be created in accordance with a preferred embodiment of the present invention;

FIG. 13 is a flow chart that describes the process of extracting health data from files of blood-relatives and updating the user's own file in accordance with a preferred embodiment of the present invention;

FIG. 14 is a block diagram that displays the structure of a knowledge base in accordance with a preferred embodiment of the present invention;

FIG. 15 is a flow chart that demonstrates the process of expert medical consultation in accordance with a preferred embodiment of the present invention;

FIG. 16 is a flow chart that shows the process of sending and running an application, such as a Java Applet, sending data to a user's PC where this data is not transmitted to the application web site that is in accordance with a preferred embodiment of the present invention;

FIG. 17 is a screen capture of a calendar entry form that may be used to keep a daily, weekly, monthly or annual journal log of medications, symptoms, and appointments in accordance with a preferred embodiment of the present invention; and

FIG. 18 is a flow chart that presents a procedure to create an episodic summary that provides a time-series snapshot of a medical symptom in accordance with a preferred embodiment of the present invention.

### DETAILED DESCRIPTION OF THE INVENTION

A description of preferred embodiments of the invention follows.

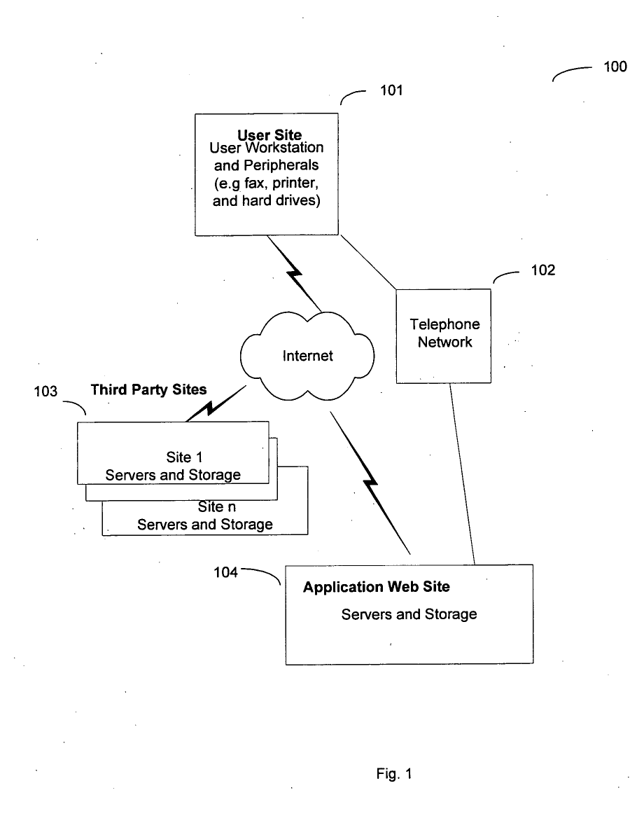

FIG. 1 is an example of a web-based application 100 for tracking data, such as personal medical history. The web-based application includes an application web site 104, one or more storage components (not shown) at a user site 101, or a third-party storage site 103 to store and process medical data. The application web site 104 temporarily stores medical data during a user session. Processing of this medical data continues until the end of the user's session. Further, the user chooses to retrieve reports based on this data. The reports are generated in various formats such as XML, RTF, and PDF. Once the reports are generated, they are downloaded or faxed over a telephone network 102 to a user designated location. In addition to the reporting feature, data is analyzed to determine specific medical information, for example, creating a health risk assessment based on body weight or blood pressure. The data itself can be stored in a longitudinal manner which refers to data items that possess different values over time. For example, longitudinal data can be the weight of a person which may fluctuate over a lifetime. Using this longitudinal data, a histogram of a person's weight over time displays periods of being underweight, normal weight, and overweight. Once processing of all the user's data, i.e., the user's session, is complete, the user's data is erased. To persist data, the user exports the data in a system-defined format to the user's site 101 or to a third-party site 103 for storage. To export this data, the user has various export interfaces to choose from, such as email or fax. This provides the user a way to safely store personal medical data.

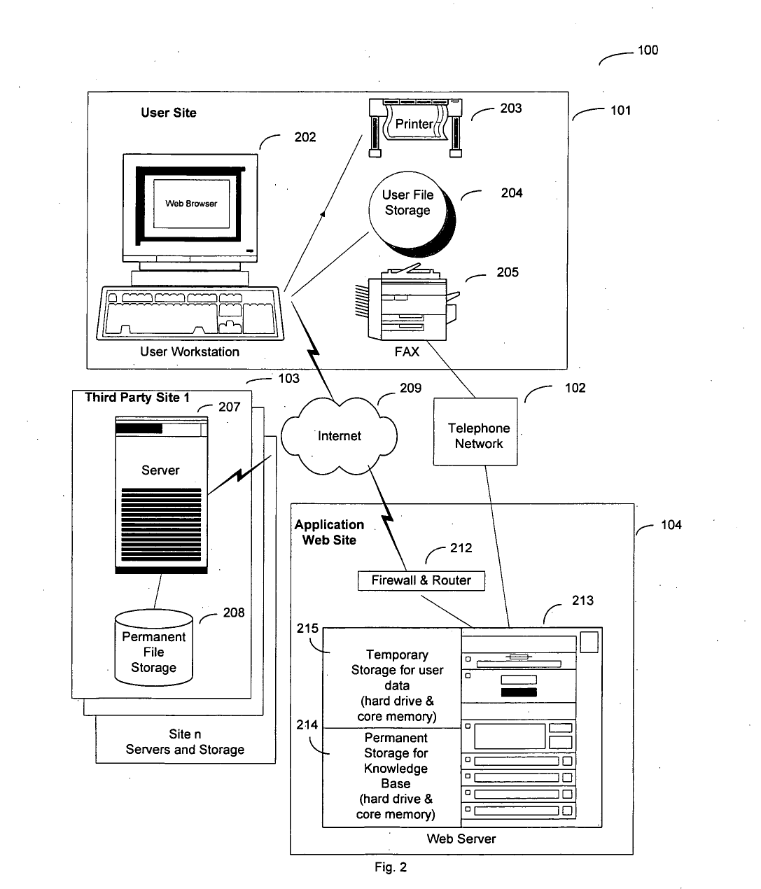

FIG. 2 provides further details of the web-based application 100 for tracking medical data of the present invention. In the web-based application, a user workstation 202 through the Internet (or similar global network) 209 interfaces with an application web site 104 in order to use an electronic medical information system. To begin using the electronic medical system a user must create or restore a valid user session. That is, the user creates a new personal medical history session from the user workstation 202 or the user restores an existing user session on the application web site 104. For a new session, the application web site 104 displays various forms containing pre-defined data fields usually unpopulated. For a restored session, the user must first upload a saved copy of data from the previous session to the application web site 104. Based on the uploaded information, the application web site 104 displays populated fields of the forms. With a populated data form, the user makes edits and/or updates. As the data changes, the application web site 104 validates the data values to ensure accuracy. At any time during this process, the user saves and exports all the personal data from the application web site 104 to a user file storage 204.

Alternatively, a third-party site 103 may also be used at the user's option for storing data to a third party permanent file storage 208 during this process. The third-party site 103 includes a respective server 207 and file storage 208. However, in order to store data at a third-party web site 103, the third-party web site 103 must be able to receive encrypted binary data files for a user. Further, the third-party web site must be able to send each binary encrypted data file back to the application web site 104 by commands based on a scripting or programmatic interface protocol. For instance, a user asks the application web site 104 to send the personal data as an email attachment to the user's account at an email service provider such as hotmail. Subsequently, the user logs on to the hotmail account and forwards the email back to the application web site 104 which will process the attachment and import the saved data, thus restoring a saved session. However, when using a third-party web site 103, the third-party web site 103 supports web (or FTP) services, one of the web services may only allow transmitting of files if the correct filename(s) and password(s) are supplied. In such a case, the application web site 104 prompts the user for filename, password, and third-party URL so as to be able to directly interface with the third-party web site 103 for sending or retrieving user data. It is important to note that in the interest of security, the application web site 104 does not store the filename or password within permanent storage 214 on the application web site 104. That is, when the user logs off, all the user's personal data is erased from the application web site's 104 permanent storage 214.

The application web site 104 has a firewall and router 212 or similar network communications interface between server 213 and global network 209. The application web site 104 stores all personal data in temporary storage 215 (e.g., core memory or temporary disk files). User data is only stored temporarily in the application web site 104 as indicated in the temporary storage 215 of application web site 104. In the event data requires longer storage, there is also a permanent storage area 214. The permanent storage area 214 contains a knowledge base. “Knowledge” is expressed as software programs where the program logic represents the knowledge, e.g., an image edge detection algorithm. “Knowledge” is also expressed as rules which are triggered by a rule-engine in the application web site 104. Using the knowledge base rules along with the personal data, data analysis is done during a user session.

A user session is defined as the duration while the user from the user site 101 is interacting on the Internet 209 with the application web site 104. The user session begins when a user logs in. While the user session is in progress, the application web site 104 offers additional services to the user such as data analysis, reminder registration, or web searches based on the personal data the application web site 104 is storing in temporary storage area 215. For example, if the personal data is related to a user's personal health history, one of the services that can be invoked is a health risk assessment module. Based on the person's height and weight, the web application computes the body mass index (a standard from the World Health Organization) to determine if a person is overweight and obese. An example of a reminder registration is the web application's vaccination calendar. If a person has entered data about immunization history, the application web site 104 will know when it is time for the next inoculation based on rules in the knowledge base of application web site 104. The application web site 104 prompts the user for an email address, fax or voice phone number and informs the user that an alert email, or fax, or phone call will be made to the user to inform of the pending event. Finally if a user is determined by the application web site 104 to have a high probability of contracting a disease, the application web site 104 provides medical advice by searching the web for relevant material to the disease. The application web site 104 also connects a user to human medical experts in an anonymous fashion in on-line or off-line modes.

Prior to the end of a session, a user saves the session to a file on the user workstation 202, i.e., the user's local PC, prints the data to a printer 203 at the user's site 101, sends the saved data to a third-party web site 103 (e.g., via email or web services or FTP), or even directs the application web site 104 to fax data reports in plain ASCII text to a fax 205 on the user's site 101. The user session will end when a user explicitly logs out from the web application by issuing a log-out command or when a session has timed out due to the user not interacting with the application web site 104 for a pre-determined time period. When the session ends, the application web site 104 erases all the personal data relating to the user from memory and temporary files.

It is observed that this exemplary embodiment is altered in a variety of ways without departing from the spirit and scope of the invention. In particular, this embodiment is not intended to be the broadest expression of the invention. The operations of the modules of FIG. 2 will now be further described to illustrate how the present invention provides a safe method for users to keep track of longitudinal personal data over time without compromising the privacy of the data because the data is not stored permanently at the application web site 104.

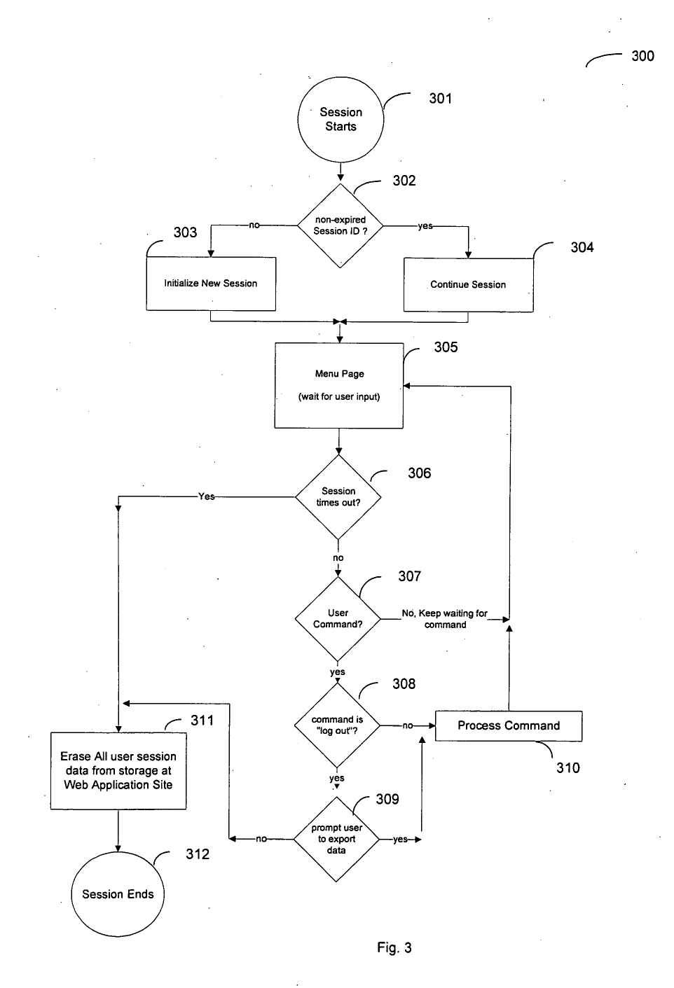

FIG. 3 is an example of a user session process 300. To begin a session 301, the application on the application web site 104 must determine if a non-expired session ID exists, i.e. by viewing a browser cookie. In step 302, if a non-expired session ID exists, then data for the user still exists in temporary storage 215, thus the application continues the user's existing session as seen in step 304. On the other hand, if the session ID in step 302 has expired, the application will initialize a new session in step 303 and assigns the user a new session ID, i.e., a cookie is sent to the browser with the new session ID value.

Once a session has been established, the user is presented with a menu in step 305. From this menu, the user selects an operation to perform such as data entry, report generation or data import/export. In order for a user to continue to issue commands using the menu a valid session must exist. At this point, a session becomes invalid by either inactivity, i.e., a time out in step 306, or by the user logging out in steps 307 and 308. To prevent a time out in step 306 from occurring while the user is active, each time the user enters a command from the menu, a session clock is reset (not shown) in step 310. In order for the session to expire, the session must time out as seen in step 306, or the user must initiate a log-out command as seen in steps 307 and 308. In either of these cases, the application will mark the session ID as expired.

If a user explicitly issues the log-out in steps 307 and 308, the application will prompt the user to export the data in step 309 and then erase all data associated with the session. However, if the session has expired due to a time-out, the application will erase all data associated with the expired session as seen in step 311 for security reasons. The session process 300 ends at step 312.

To better understand one embodiment of the present invention the following is an explanation of how one might implement the management of the session data using session objects. With respect to the actual creation and life of a session, the actual data is stored temporarily within the application web site 104. The data associated with each session is kept within session objects upon creation. That is, the web-based application creates a set of session objects that contain no values. Session objects are created as instances of classes declared with an object-oriented programming language such as Java, PHP, or C#. The storage of the session objects use a database management system such as ORACLE, MS SQL, or MySQL. These session objects include the use of memory, such as cache for fast-lookup, or disk storage. In the event a user wishes to restore an old session, the user is prompted to upload personal data from an external storage resulting in the population (setting of values) of these session objects. Once the user has uploaded data, if any, data forms are presented to the user so that the session objects are edited during the session through interactive data entry and update. Data fields within the session objects have validation criteria to ensure proper entry into the data forms, for example, ensuring a user's date of birth did not occur in the future.

With respect to the data values themselves, the data values are numerical or string data types. Data validation is applied to a data field in isolation or in conjunction with a set of field values together such as a female cannot have prostate cancer. Further, when the application web site 104 is to erase data, session objects are removed from the cache memory using an object destruction feature in an object-oriented programming language. As for the session objects stored in disk storage on a database management system, these objects can be removed using the standard SQL “DELETE” command. In this way, the application ensures the removal of all relevant data for a specific session.

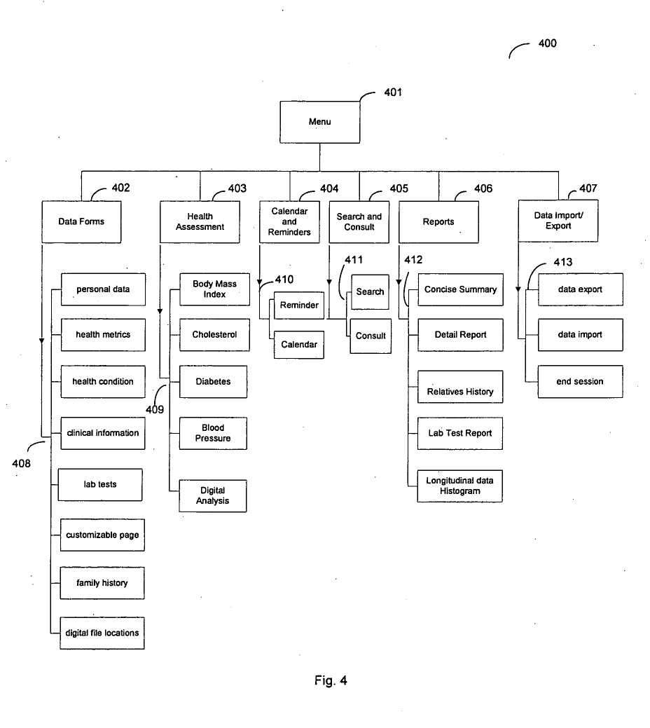

FIG. 4 provides a list of user selectable commands in a hierarchical manner 400 for one embodiment of the present invention. At the top level 401, a user is presented with various options through the menu page 305 of FIG. 3. First, the user data forms 402 may invoke a command to receive data entry forms 408 that present the data fields in an organized and structured manner. Next, a user is provided with a health assessment 403 command that is the entry point to health risk assessment modules 409. Another possible command a user may invoke is calendar and reminders 404 in order to set up scheduled alerts 410 via email or phone calls. Yet another command a user can invoke is the search and consult 405 command that will allow the user to find a specialist or receive a consultation (generally referenced 411). In addition to these commands, a user can also invoke a reports command 406 which allows the user to display the data fields in a fashion different from the data entry forms. The various reports 412 subsequently are printed and brought to a medical specialist's office. Finally, the user may issue a data import/export 407 command which will provide the user the ability to import and export any or all session data 413.

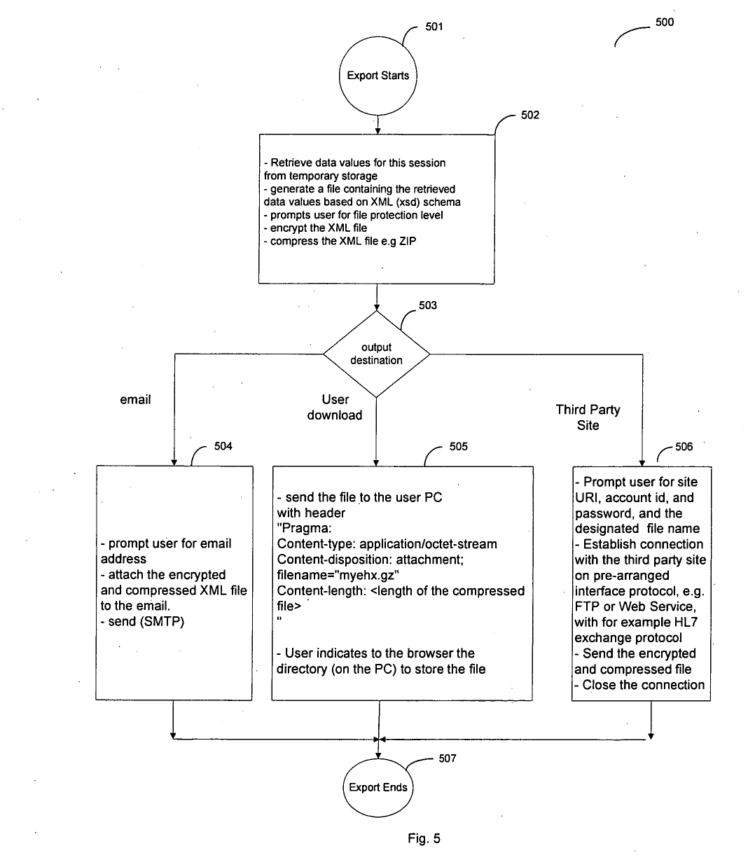

FIG. 5 provides further details on the data exporting process 500 to an external location, prior to the deletion. The export process is started 501 by retrieving data values for the session from the temporary storage 215. The data values are then captured into an XML file based on an XML schema as seen in step 502. After capturing the data values, step 502 encrypts the XML file for privacy and compresses it for quicker transmission. With regard to the encryption process, there are many different encryption/decryption algorithms available today such as Blowfish and DES. Depending on a protection level set by the user, the XML file is encrypted by both a user entered key and a system default key thus ensuring further protection. With regard to the compression of the XML file, the encrypted XML file is compressed using a utility such as zip. The compressed encrypted XML file is now exported.

To export the data, the user must first select an output destination 503 for the application web site 104. If the user selects email 504 as the output destination 503 as the means to export the data, the user is prompted for an email address, then attaches the data file and sends (transmits) the email. This provides the user with an encrypted email data file. On the other hand, if the user chooses the output destination 503 to be a user download 505 the data file can be sent using the user's workstation 202 through HTTP (with content-type as application/octet-stream). Similarly, the data file can also be transmitted to a third-party site 506 via any file transfer mechanism, i.e., ftp or web service, after proper authentication. The interchange between the third-party web site and the application web site 104 is FTP, where a data file containing the part or all of user data is transferred. The actual content of the data file is specified using XML or other message transfer protocol such as HL7.

With regard to the data file protection levels used during export from the web application, the user selects one of the following file protection levels 502:
Default system protection—Any one who possesses a copy of the file can upload the file to the web application, the file is decrypted based on the web's default decryption key and the data is then viewed or modified.
Password protection—Any one who possesses a copy of the file can upload the file to the web application which decrypts the data based on the web's default decryption key. Anyone may input new data to the file. However, in order to view or modify the data file the user must also provide a proper password. Different passwords may be assigned to different data entry forms so that each data form may be protected by a different password. The passwords are saved in the exported file itself and subjected to the same encryption/decryption procedures as the rest of the data.
User Encryption—Any one who possesses a copy of the file must also provide a user encryption key. The key is used to encrypt the export file in lieu of the system default encryption/decryption key. In this mode, editing and viewing are only allowed when the key is provided. The user-supplied encryption key is external to the file and it is the responsibility of the user to safeguard the key at a secured storage.

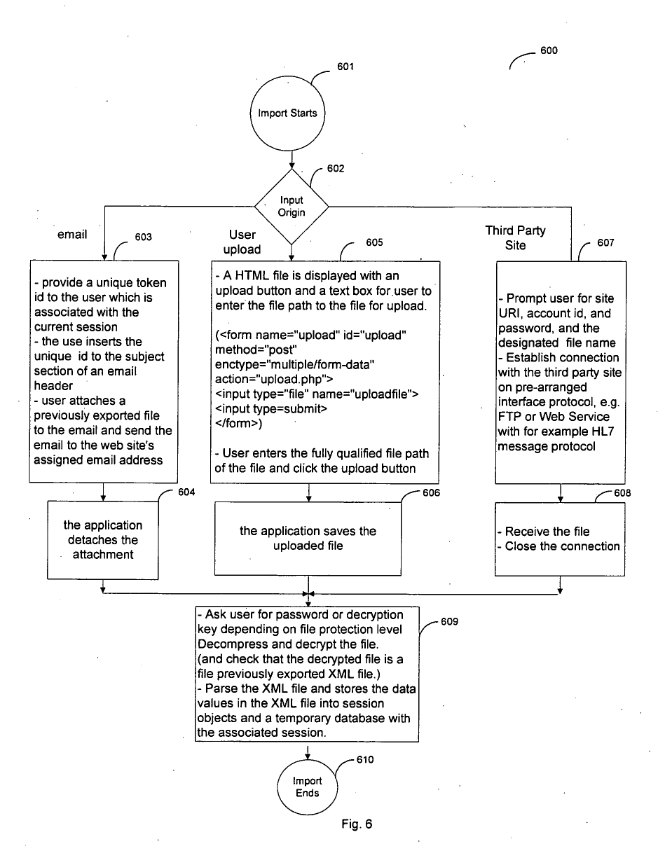

FIG. 6 depicts the process 600 for to importing saved data from an external location. A user imports data at any time during a session. Further, the user has the option of using the imported data to overwrite all existing session data or a session with no data. To begin 601 the import process 600, the application web site 104 must first determine the input origin 602. In one embodiment of the present invention, the user imports data from email, HTML or a data file from a third party site. In an HTTP upload method 605, an HTML form is presented where one of the input fields is of type “file”. A browser such as Internet Explorer (IE) allows a user to browse the local file directory to choose a file to upload. Note that this chosen file is the same file exported from the web in step 505 of FIG. 5. Ultimately the application web site 104 saves the uploaded file at step 606.

If, on the other hand, the user exports the data using email 603, the user is given a token id which associates the email from the user to the corresponding session. Using this token id embedded in an email subject header and the file attachment, the user imports the email attachment to the application web site 104. This email attachment is the same file as produced in step 504 of FIG. 5. Application web site 104 detaches the email attachment at step 604.

Finally, if the user selects the input origin 602 to be a third-party site 607, the user is prompted for a user account, access password, file name and location of the third-party site. In turn, the application web site 104 retrieves the file and imports the data to the session (step 608). The interchange between the third-party web site and the web application is FTP where either part or all of the user data is transferred. In addition, the data within the file can be specified using XML or other message transfer protocol such as HL7.

Once the user has completed the initial download process (steps 603-608), the user must satisfy all security precautions. That is, the user must provide a password or decryption key to complete the process in step 609. After all appropriate security measure are satisfied, the XML file is parsed in order to extract and store the data elements. The import process ends at step 610.

In the import process 600, the application web site 104 is capable of storing both textual and digital data. In the case of textual data, the application web site 104 can parse either UTF-8, UTF-16, or UTF-32 encoding for English and non-English character sets using a XML tag like:

<?xml version=“1.0” encoding=“UTF-8”?>.

An example of a XML export file with textual data may look like the following before encryption and compression:

<?xml version=“1.0” encoding=“UTF-8” ?>
<myehx xmlns=http://www.myehx.com/myehx

xsi:schemaLocation=http://www.myehx.com/myehx/myehx.xsd
xmlms:xsi=http://www.w3.org/2001/XMLSchema-instance>

<table name=“health metrics”>
<item name=“weight” unit=“lb” value=“150” />
<item name=“height” unit=“ft′in” value=“5′6” />
<item name=“total cholesterol” unit=“mmol/L” value=“220” />
</table>
<table name=“medications”>
<item name=“Allopurinol” dosage_unit=“mg” dosage_value=“300”

start_date=“1995-01-01” end_date=“” />

</table>
<table name=“relatives”>
<item name=“father” yearOfBirth=“1910” health=“”
yearOfDeath=”1994”

causeOfDeath=“LLC” knownProblems=“”>

<item name=“mother” yearOffBirth=“1918” health=“”
yearOfDeath=”2004”

causeOfDeath=“Metastasis” knownProblems=“Digestive
Problems”>

</table>
</myehx>

In the case of digital files, a common way of embedding binary data into an XML document is to use base64 encoding. This is handled by the application web site 104 using a software module that implements base64 encoding and decoding to compress and recreate a digital file. The following is a fragment of a XML file containing based64 encoding digital data:

<?xml ... ?>
<myehx ...>
...
<table name=“demographics”>
<item name=“yearOffBirth” value=“1951” />
<sex value=“M”>
</table>
...
<table name=“digital”>
<digitalItem name=“CTScan”
xmlns:dt=url:schemas-microsoft-com:datatypes

dt:dt=“bin.base64” organ=“brain” view=“front cross-section”
date=”2001-09-12”>

EAbEA ...GabkCoHE
</digitalItem>
...
</doc>

To specify which XML tags contain digital images, a schema definition is used. A proposed schema definition standard from the NISO Technical Metadata for Digital Still Images Standards Committee is “NISO Metadata for Images in XML (NISO MIX)”. A draft of the standard is published at URL http:/www.loc.gov/standards/mix/mix.std. In practice, if the XML document that the application web site 104 is importing contains fields with embedded digital images, the application web site 104 stores each of the digital images as a data type “blob” or “longvarbinary” in a relational management database such as Oracle, Microsoft SQL server, or MySQL. The digital images can later be exported by reversing the procedure. That is, the application retrieves the binary data from the database, using an encoding algorithm such as base64 to transform the data, and inserts the transformed data into the corresponding XML tagged field in the XML file.

Another way digital files can be imported into the application web site 104 is using URLs. In a typical situation, these digital files are stored at a hospital's digital imaging systems or other electronic health record systems. If an XML tag is defined to be a pointer to one of these digital image files, during XML parsing the application web site 104 retrieves the file automatically from the specified location, i.e., a URL. In some cases, the user may have to provide account and password in order for the application web site 104 to retrieve the file. To resolve this problem, if the security of the remote site permits, the account and password is inserted into the URL (e.g., https://account:password@www.third-party.com/xxx.jpg) thus providing the necessary authentication. For further security in the import process, the application web site 104 supports both HTTP and HTTPS (SSL) protocols.

The following is an example of an XML file using a URL defined by Xlink pointing to a .jpg file located on a third-party web site.

<?xml ...>
<myehx ...

xmlns:xlink=”http://www.w3.org/1999/xlink/namespace/”>

...
<table name=”digital”>
<digitalItem name=”CTScan” date=”2004-01-29”

xlink:type = ″simple″
xlink:href = ″http://www.third-party.com/myctscan.jpg″
xlink:title = ″My CTScan″
organ=”brain” view=”front cross-section”>

</digitalItem>
...
</doc>

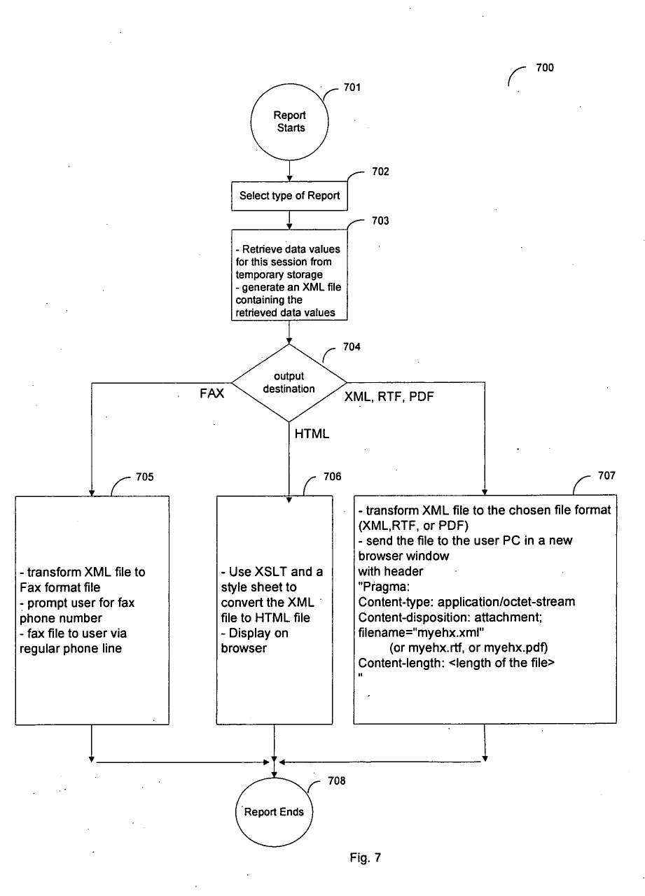

FIG. 7 illustrates the process 700 of creating reports 406 of FIG. 4. The reporting process 700 begins at step 701. A user selects one or more of a variety of reports in step 702 such as personal health history summary and blood relatives' health history. For each type of report, the application 104 fetches the session data values from temporary storage and generates an XML file in step 703 based on a pre-defined XML schema corresponding to the type of report chosen. In step 704, if the output destination is fax, the G4 file is transmitted by facsimile to the user's designated fax phone number in step 705. On the other hand, if the output destination in step 704 is XML, RTF, or PDF, the file is downloaded to a new browser window on the user's workstation 202 where the appropriate viewer is automatically invoked. To view the report in a browser, the XML file is converted by XSLT based on a style sheet into HTML file and then sent to the browser in step 706. Further, the XML file may have to be transformed from XML to fax format (e.g., G4), or RTF, or PDF in step 707. Commercial software packages are available to perform such transformations, such as the ImageMAKER Web to Fax product by ImageMAKER Development Inc., RTF Generator from Paggard, and PDFlib from PDFlib GmbH. The reports process 700 ends at step 708.

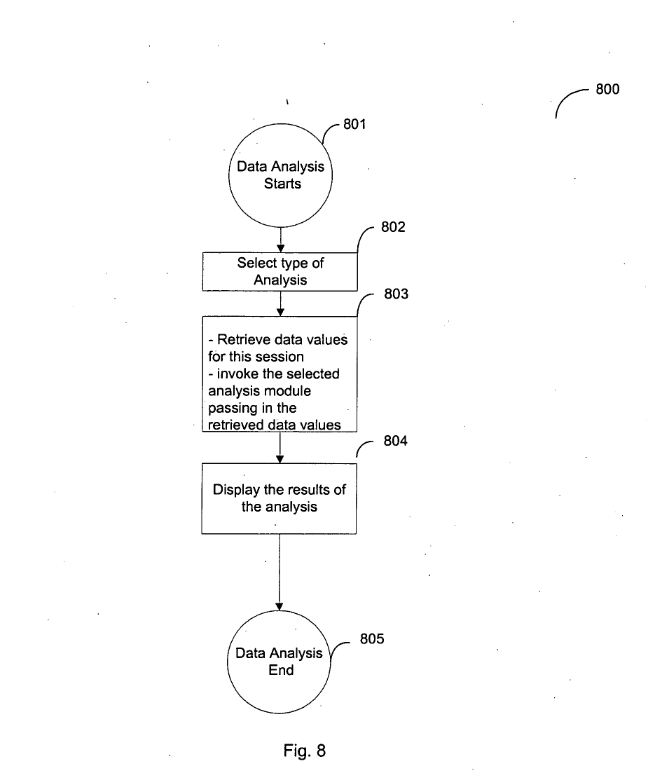

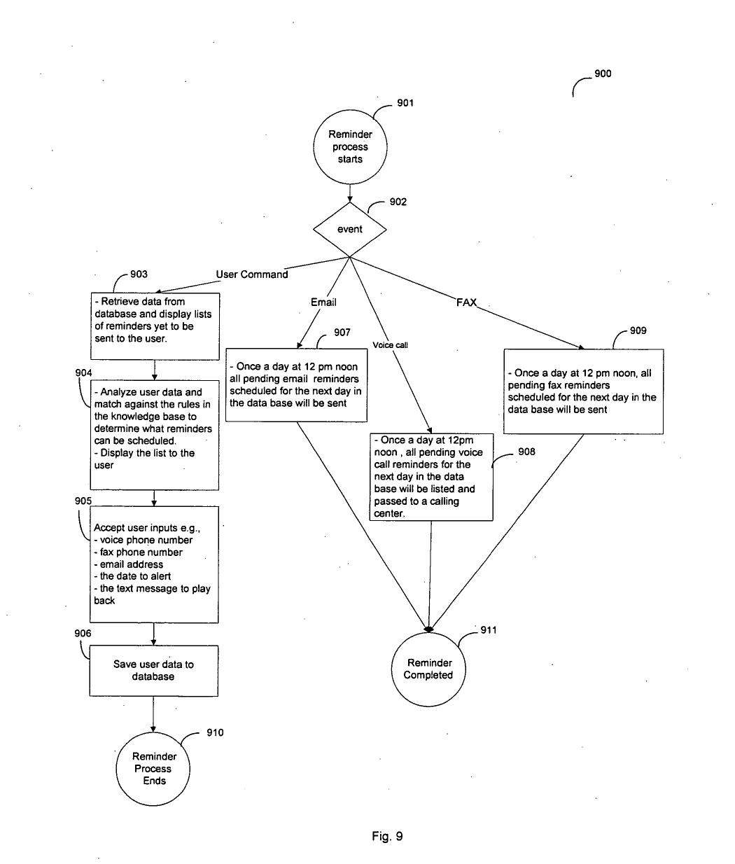

FIG. 8 shows the process 800 of data analysis using the application web site 104. Data analysis process 800 is initialized at 801. In step 802, the user may select the type of data analysis to perform. In step 803, the application web site 104 retrieves data values from the session and passes the data values to the selected analysis module. This selected analysis module performs calculations and returns the results to an HTML page. These results then are displayed to the user in step 804 thus completing 805 the data analysis process 800.

An example of the data analysis process 800 can be shown using a Body Mass Index (BMI) analysis. First the data values from the session are retrieved by the application web site 104. These data values are retrieved from the user entering the weight and height. With these data values, the application web site 104 passes the values to a BMI module, i.e., the selected analysis module. Next, the BMI module converts the data if necessary and computes the BMI using the formula, i.e., weight in kilograms/(height in meters*height in meters). Finally, the BMI module displays four different ranges to indicate normal (below 18.5) and three categories of abnormal ranges in increasing level of severity. In addition, links (such as the web site at the National Heart, Lung, Blood Institute) are provided to the user for reference information.

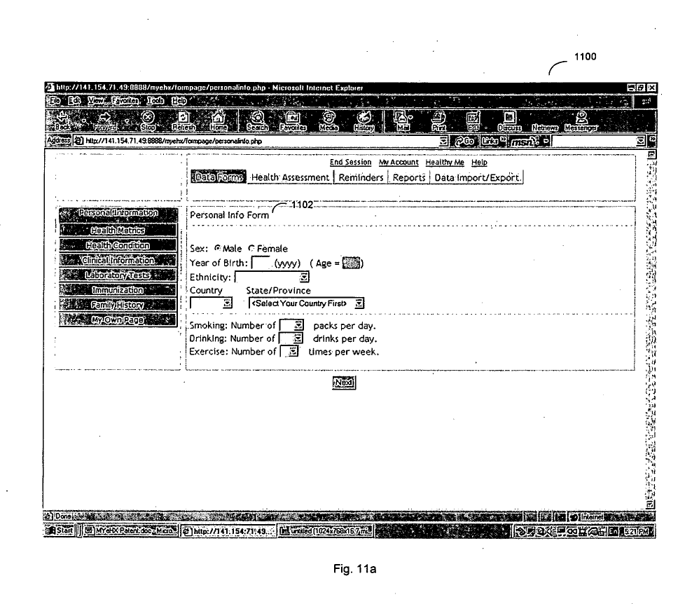

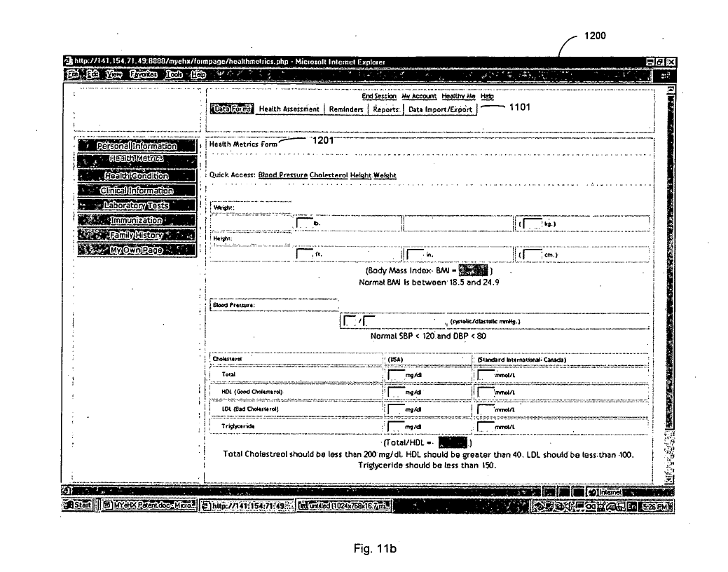

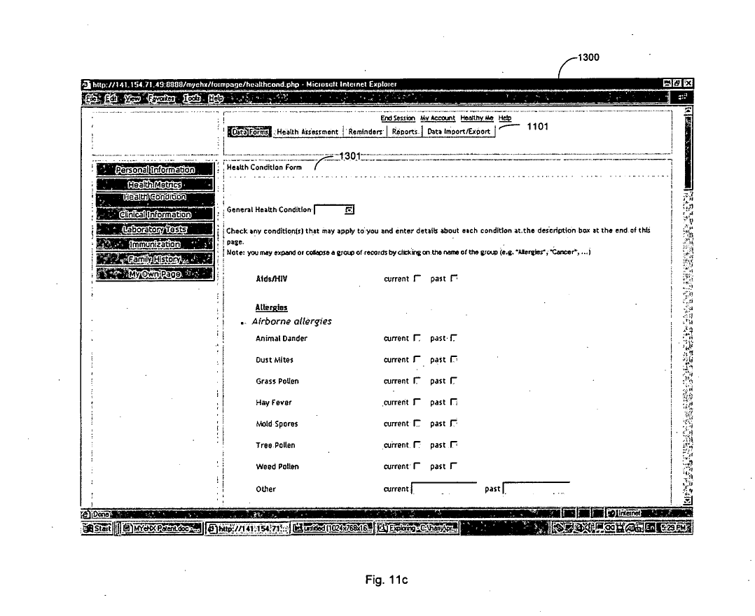

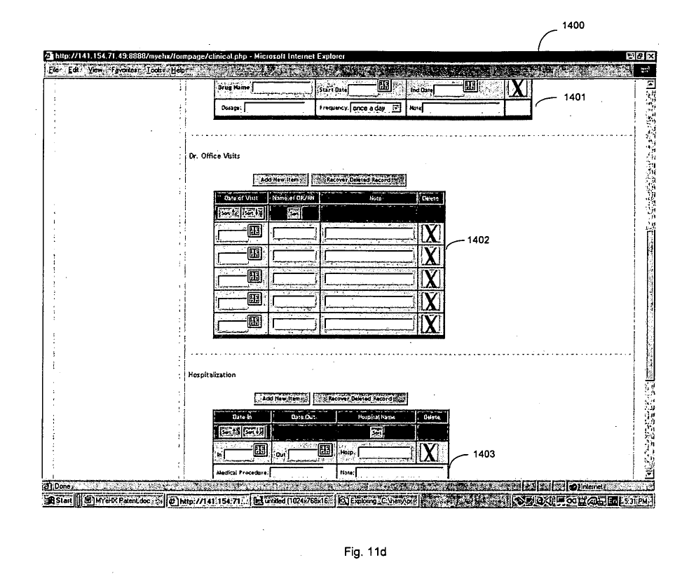

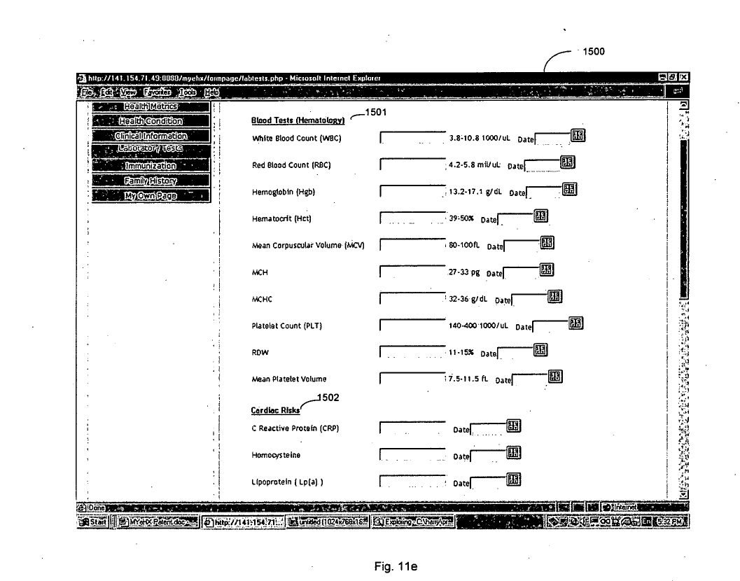

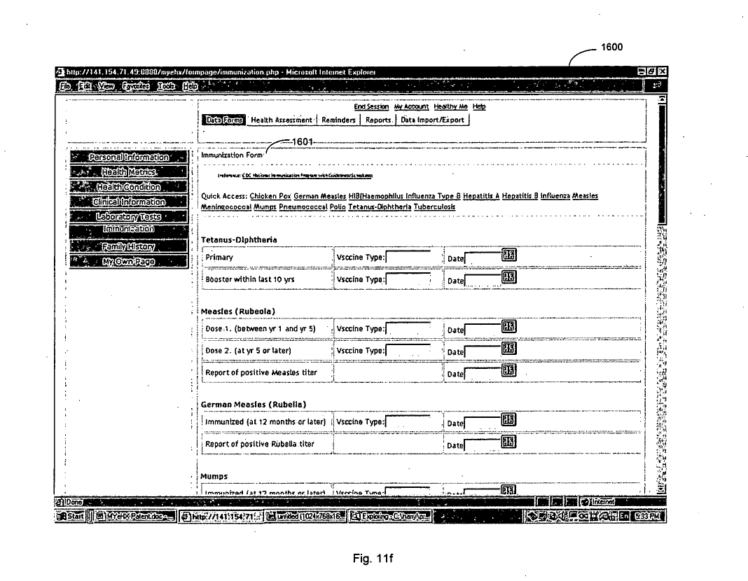

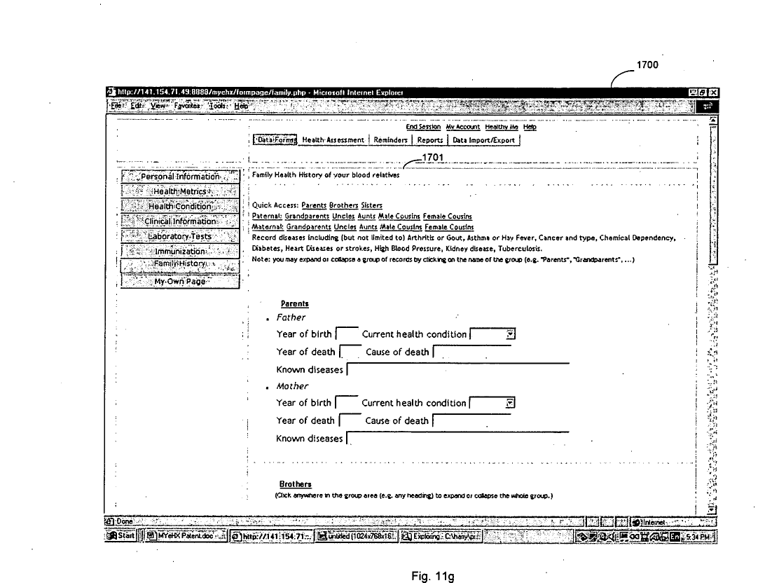

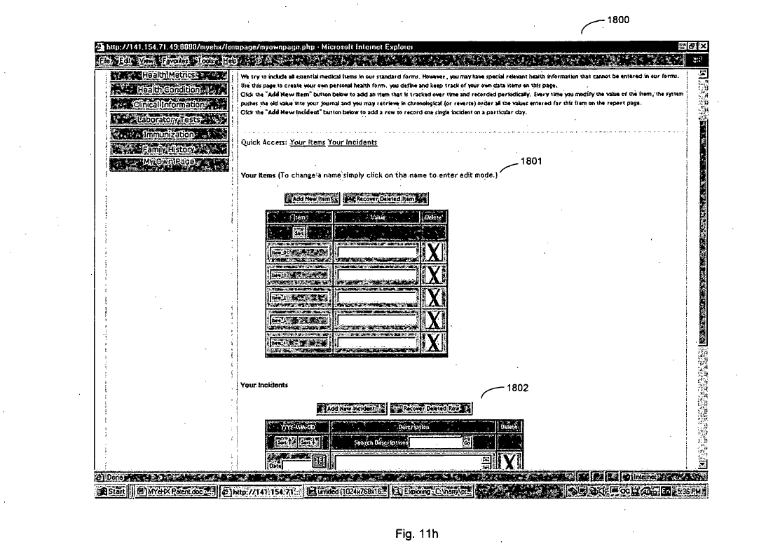

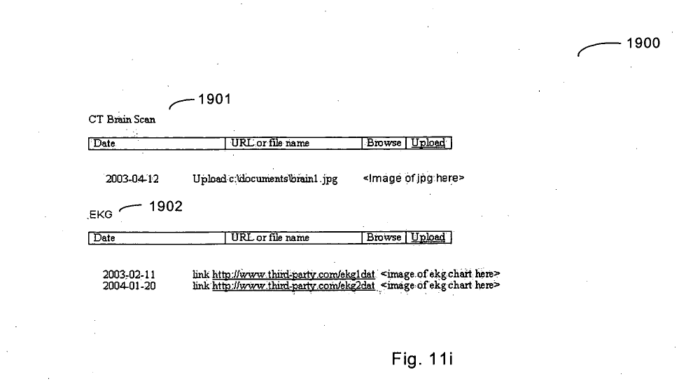

Another example of using the data analysis process 800 is the automatic detection of abnormalities through the digital analysis, image processing and pattern recognition of digital image files, i.e., detecting of a lung nodule in a chest digital image. Yet another example of using the data analysis process 800 is the travel immunization risk assessment module. Specifically, the user using the data form in FIG. 11f (described later) enters the travel destination and the application web site 104 searches for information about the immunizations that should be administered. The application web site 104 then matches the immunization requirements with the user's immunization record and alerts the user to the necessary immunizations and the potential diseases that may be contracted if the indicated immunization is not applied.

FIG. 9 describes the process through which the application web site 104 creates and processes reminders. To begin 901 the reminder process 900, an event must be configured to occur in step 902. Examples of such events would be a user command, email, voice call or fax. If the event in step 902 is a user command then a user may create a new or edit an existing reminder. Using the application web site 104, the reminder page is loaded by providing a unique ID and password. If no reminder page exists for the user, a unique reminder page ID is assigned. Once the reminder page is created or restored, the reminder page shows all pending reminders scheduled to be sent in step 903. The reminder page also shows a list of potential events in step 904 by applying rules in a knowledge base 214, i.e., flu shot should be taken annually before the flu season starts, to the user's data. The user then may include some of these potential events to a pending reminder list. The application 104 (reminder process 900) accepts the user's input in step 905 for information such as fax number, voice phone number, email address, postal address, date the reminder should be sent, a text message to be sent with the reminder. Next application 104 reminder process 900 saves the received user data to the database (step 906), and ends at 910.

On the other hand if the event of step 902 is an actual reminder being sent using application web site 104, the user reviews the appropriate communication. For all types of reminders once a day, the application web site 104 retrieves all reminders that are scheduled for next day and processes them. Following this processing, an email in step 907, a voice call in step 908 and a fax to an indicated number in step 909 is sent to the user. With regard to the voice call, a voice call will be made by either a person manually or an automated phone system with text to voice announcement capability. Regardless of the type of reminder, each reminder item is stored with the following fields: (1) date of event, (2) time of event, (3) fax/phone/email, (4) destination address, (5) brief description, (6) the rule number in the knowledge base 214 which creates the event unless the item is entered explicitly by a user, and (7) a detailed description ID to a more detailed description. The reminder item is completed at step 111.

Because the data for a reminder is stored on the application web site 104, a user may wish to preserve anonymity and privacy. Content in the destination address (e.g. phone number or postal address) will identify a person to a certain extent. It will be left to a user to seek means outside of the system to preserve anonymity of destination address from third-party services, i.e., by using anonymous mailbox and forward services. As a security precaution, the application web site 104 encrypts all sensitive data. In addition to encryption, the application web site 104 also creates a brief description and detailed description ID fields that are used to minimize the sensitivity of the data stored on the web.

For example, these fields could store a reminder that alerts a user to a scheduled appointment to a clinic for chemotherapy. The brief description of an email is simply “scheduled appointment #1678”. Where #1678 is a detailed description ID that relates to the following detailed description: “See Dr. Smith at the Boston Clinic for next installment of chemotherapy of my liver cancer”. The brief description is then sent back to the user as part of the reminder process and is stored on the application web site 104 until the event expired. Both the brief and detailed descriptions fields are entered by a user and in turn, the application web site 104 automatically assigns IDs and link them. The detailed description remains on the application web site 104 only for the duration of the session. The application web site 104 assigns a detailed description ID to each detailed description and stores the ID in the reminder. The detailed description is then stored in a save file that the user downloads prior to end of a session. When a user receives a reminder such as “schedule appointment #1678”, the user logs in to the application web site 104 and uploads the saved file. If the user desires, the detailed description then is retrieved based on the detailed description ID.

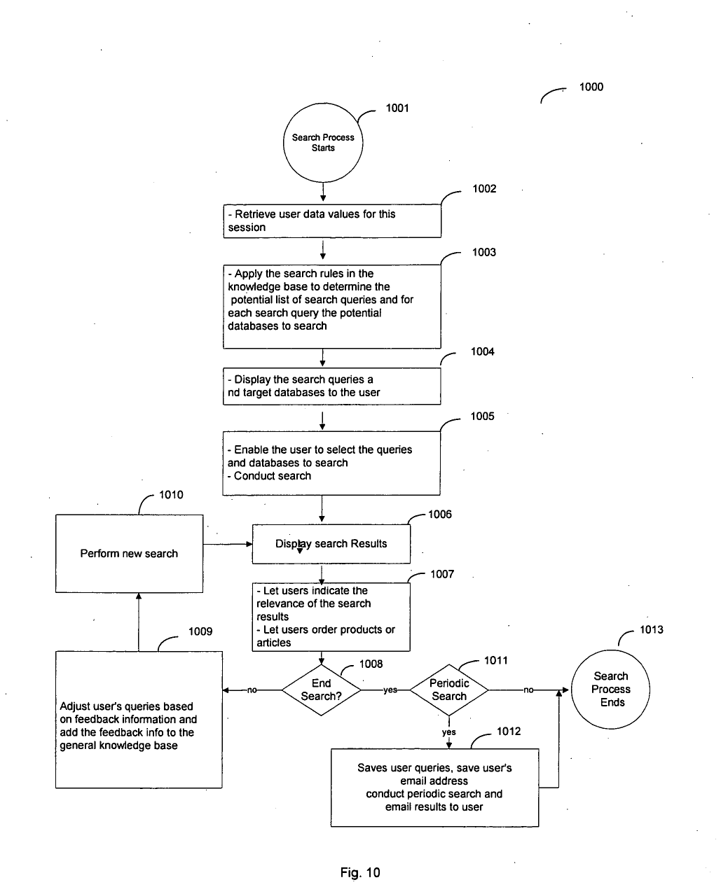

FIG. 10 details a search process 1000 for the application web site 104 to search various databases based on a user's personal data while storing the data temporarily. Process 1000 starts at 1001. In step 1002, the user's personal data for the current session is retrieved. After retrieving the personal data, the knowledge base 214 rules are applied to the user's data in step 1003. An example of this would be if the user's cholesterol level is high create two queries. The first query searches for information about the adverse effects of high cholesterol to a person's health. The second query searches for info about the medical treatments for high cholesterol.

Next, in step 1004, all these potential queries are shown to the user together with a list of relevant databases for each query. A user may go on to select one or more of the queries with or without modifications in step 1005 and then initiate a search. The results of the user's queries are then displayed in step 1006. Based on the query results, a user may choose to end the search process or continue a new search 1010 based on “relevance feedback” techniques in step 1007. These “relevance feedback” techniques (step 1007) are generally proposed by researchers in the field of Information Retrieval. For example, a user may mark certain results as relevant and others as non-relevant. These two distinctions are viewed as training sets for Artificial Intelligence learning within the knowledge base in order to create new rules. With these new rules, new queries are created (step 1009) for the user and new searches 1010 can be conducted.

This feedback process continues until the user explicitly stops the search process 1000 in steps 1008 and 1013. Finally, when the user is finished, the user may save the queries. That is, in step 1012, the user has the option of saving the queries on the web, and the application web site 104 conducts searches periodically (step 1011) based on the saved queries. Search results for these saved queries are emailed to the user at the user's designated email address. At the option of the user, the saved queries are submitted by the application web site 104 on behalf of a user anonymously to commercial vendors for information. The information from these commercial vendors is forwarded by the application web site 104 to the user via email. In this way, the user's anonymity is preserved while still enabling the user to obtain pertinent healthcare information related to the user's personal health data.

Within the health care industry there exist many databases that searchable information. For example, PubMed Central at the US National Library of Medicine is searched for publications in biomedical and life sciences whereas Amazon.com is searched for books and other medical related products. Some databases may provide programmatic interfaces. For example, the PubMed Central OAI service (PMC-OAI) provides access to metadata of all items in the PubMed Central (PMC) archive, as well as to the full text of a subset of these items. In addition, Amazon E-Commerce Service provides product categories, information, and images. Where programmatic interfaces to interact with a database are not available, the application web site 104 resorts back to the techniques of web crawling and screen scraping. Unlike the databases described above, not all pertinent information is free such as text article. These items that require payment are provided for by the application web site 104 via an electronic storefront that enable users to order and pay for these items. At the user's discretion, the storefront orders the items on behalf of a user so that the user's identity is kept secret from the clearinghouse where the items are purchased. The items will be shipped to a warehouse and then forwarded to the user.

Instead of the user searching for an answer using data, the application web site 104 may also send the user's data in an anonymous fashion to a human expert. For example, if the user is overweight, the application web site 104 extracts pertinent information from the data based on rules in the knowledge base 214 and sends the information anonymously to one or more human experts for advice. The advice from these experts is forwarded by the application to an email address, a third-party web site, or fax phone number designated by the user.

In another embodiment of the present invention, the application web site 104 provides a “private chat” or “private instant messaging” for a user to communicate with a medical expert directly in real time. The user's identity is kept anonymous but the expert's identity is not. The user may decide what data to show to the expert and may choose what expert questions to answer.

Data entry is done using a variety of data forms. Using these data forms, the application web site 104 organizes and groups personal health data elements. The data forms 1100, 1200, 1300, 1400, 1500, 1600, 1700, 1800, 1900 of one embodiment of the present invention can be seen in FIGS. 11a-11i as follows:

FIG. 11a shows a partial view of the Personal Info Form 1102 such as Blood Type, Sex, Year of Birth, Ethnicity, Country, State/Province, Number of packs of Cigarettes per day, Number of drinks per day, Number of times of exercise per week.

FIG. 11b shows a partial view of the Health Metrics Form 1201 with fields such as Weight, Height, Blood Pressure (Systolic and Diastolic), Total Cholesterol, HDL, LDL, and Triglyceride.

FIG. 11c shows a partial view of the Health Condition Form 1301 containing fields such as General Health Condition (with values from 1 to 5 where 1 is poor and 5 is excellent), Aids/HIV, Airborne Allergies (Animal Dander, Dust Mites, Grass Pollen, Hay Fever, Mold Spores, Tree Pollen, Weed Pollen, Other), Food Allergies (Egg, Fish/Shellfish, Milk, MSG, Peanut, Strawberries, Wheat, Other), Drug Allergies (Anti-seizure Drug, Aspirin, Barbiturates, Insulin, Iodine, Lidocaine, Local Anesthetics, Penicillin, Sulfa Drug, Other), Alcoholism, Anxiety, Arthritis, Bleeding Disorder, Cancer (Bladder, Breast, Colorectal, Endometrial, Kidney, Leukemia, Lung, Melanoma, Non-Hodgkin's Lymphoma, Ovarian, Pancreatic, Prostate, Skin: non-melanoma, Other), Cardiac Disease, Chemical Dependency, Depression, Diabetes, Digestive Problems, Epilepsy, Heart Diseases, Hepatitis, High Blood Pressure, High Cholesterol, Impotence, Kidney Diseases, Liver Diseases, Migraines, Pneumonia, Psychiatric Problems, Respiratory Problems, Sexually Transmitted Diseases, Strokes, Tuberculosis and Urological Conditions.

FIG. 11d shows a partial view of the Clinical Information Form containing fields such as Medications 1401 (Drug Name, Dosage, Start date, End date, Frequency), Doctor's visit 1402 (Name of Doctor and date of visit), Hospitalization 1403 (Name of Hospital, Date In, Date Out, Medical Procedure, Discharge note summary).

FIG. 11e shows a partial view of the Laboratory Tests Form containing fields such as Hematology 1501 (WBC, RBC, Hgb, Hct, MCV, MCH, MCHC, PLT, RDW, Mean Platelet Volume) and Cardiac Risks 1502 (CRP, Homocysteine, Lp(a)), Lipid(Cholesterol Total, HDL, LDL, Triglyceride), Colorectal Tests (Colonoscopy, DCBE, FOPT, Signoidoscopy), Hormones (C-peptide, Estradiol, Insulin), Kidney Tests (BUN, Creatine, Uric Acid), Liver Tests (ALP, ALT, SGPT, AST, SGOT, Bilrubin, GGT), Men's Healthcheck (DRE, PSA), Minerals (Calcium, Phosphorus), Proteins (Albumin, Globulin, Total Protein), Sugar(Glucose, Glycohemoglobin), Thyroid (Free T3, Free T4, FT1, T7, T3 Resin Uptake, TSH, Total T3, Total T4), Urinalysis (pH, SG, Bilirunin, Blood, Glucose, Leukocyte esterase, Nitrate, Protein, Sediment), Women's Healthcheck (Mammogram, DXA/DEXA, Portable pDEXA, Sahara Clinical Bone Sonometer, Pap Smear).

FIG. 11f shows a partial view of the Immunization Form 1601 containing fields such as Tetanus-Diphtheria (Primary and Booster), Rubeola (Dose 1, Dose 2, Dose 3), Rubella, Mumps, Polio, Tuberculosis, Vaircella, Hepatitis A (Dose 1, Dose 2), Hepatitis B (Dose 1, Dose 2), Influenza, Haemophilus Influenza Type B (Dose 1, Dose 2, Dose 3, Booster), Pneumococcal (Dose 1, Dose 2, Dose 3, Dose4), Meningococcal.

FIG. 11g shows a partial view of the Family Relatives Form 1701 containing fields such as Parents (Father and Mother), Brothers, Sisters, Paternal [Grandparents, uncles, aunts, mail and female cousins], Maternal [Grandparents, uncles, aunts, mail and female cousins]. (For each relative the following are recorded: year of birth, current health condition, year of death, cause of death, and known diseases).

FIG. 11h shows a partial view of the User Customizable Form where a user may create a new entry in the Items table 1801 with a unique name. A user may also insert new incidental events into the Incidents table 1802. These forms are user customizable to enable a user to create data items that are not pre-designed and defined by the application web site 104. When a user populates data, the data is treated as longitudinal data in the Items table 1801 and as one time events in the Incidents table 1802.

FIG. 11i shows a partial view of a digital image form where a user may create one or more data items that are digital files such as NMRIs, X-Rays, CT scans 1901, PET scans, and EKG scans 1902. The digital files are imported and exported from the application web site 104 as described in FIGS. 5 and 6.

In another embodiment of the present invention, personal health data is associated with a time, such as when a specific health data value is captured (e.g., on what date a blood test is taken) or when a health event takes place (e.g., when a person checked into a hospital for an operation.), or when a digital image is made (e.g., date of a brain CT scan). Taking data over a long period of time creates longitudinal data. In other words, longitudinal data is data that is tracked during the lifetime of a person. Each of these data items may possess many values where each value is time-stamped with a distinct time. On the other hand, non-longitudinal data refers to data items that happened once and once only. For example, the weight tracking of a person at a particular time is considered longitudinal data whereas non-longitudinal data is the tracking of an appendectomy which can occur only once. All of these types of data are classified in the application web site 104 either as longitudinal or non-longitudinal by the use of a data attribute “Repeat”. For example, if the “Repeat” attribute is TRUE then the data item has repeated a timestamped value. Conversely, if the “Repeat” attribute is FALSE then the data item will not have multiple values. The application web site 104 uses this attribute to determine how to classify the new data.

With regard to timestamping, data items acquire a timestamp implicitly or explicitly. On an entry form, a data item may or may not have explicit date input fields. P For example, on FIG. 11h, the first table (Items Table 1801) has two columns: item name and item value without date field. The second table (Incidents Table 1802) has two columns containing timestamp fields, i.e., date, and description field.

Implicit timestamping of data is where the timestamp provided is the actual time of the data entry. For example, the “weight” data item is an implicitly time-stamped data item because the timestamp provided is that of the data entry time. Stated differently, if a user enters a value of 200 lbs. for the “weight” item on Sep. 23, 2003, then the timestamp for the value 200 lbs. associated with the data item “weight” is Sep. 23, 2003. If at a later time the user logs in and enters a value of 230 lbs. for “weight” then the timestamp for this new value (230 lbs.) is associated with the same data item “weight” with a new date. Accordingly, the application web site 104 will store both values and their associated time-stamps. Below is an example of how this data is stored:

| Row id | Data Item Name | Data Value | Time Stamp | Unit |
|---|---|---|---|---|
| 19897 | Weight | 200 | 2003-09-23 | lb |
| 21111 | Weight | 230 | 2004-08-05 | lb |
| . . . | | | | |
| 27600 | Weight | 200 | 2004-10-02 | lb |

For data that has automatic timestamping, the application web site 104 provides a mechanism for the user to manage, i.e., add, modify, or delete, the values of data items. Specifically, a user edits the value of a cell by double-clicking on this cell “add a row” by selecting the button for inserting a new row/values, or use the “delete a row” to remove a highlighted row. An example from one embodiment of the present invention is seen here:

| Data Item: Weight | |
|---|---|
| Value | Date |
| 200 | 2003-09-23 |
| 230 | 2004-08-05 |
| Add a Row | |
| Delete High Lighted Row | |

For previously entered timestamped data, the timestamp can be edited or modified. For example, a user enters the date of the appendectomy operation as “Jul. 23, 2001”. A few days later, the user notices an error. The user logs into the application web site 104 and modifies the date of the appendectomy operation to “Jul. 24, 2001”. This new timestamp will replace the old timestamp of “Jul. 23, 2001”. The updated information contains only one row for appendectomy as seen here:

Table: Surgical Procedures

| Row id | Data Item | Hospital | TimeStamp |
|---|---|---|---|
| . . . | | | |
| 16731 | Appendectomy | St. Mary's Hospital | 2001-07-24 |
| . . . | | | |
| . . . | | | |

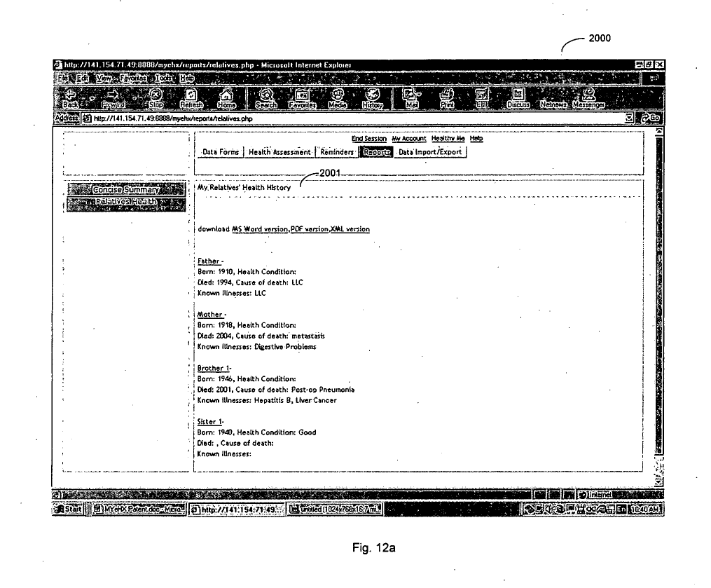

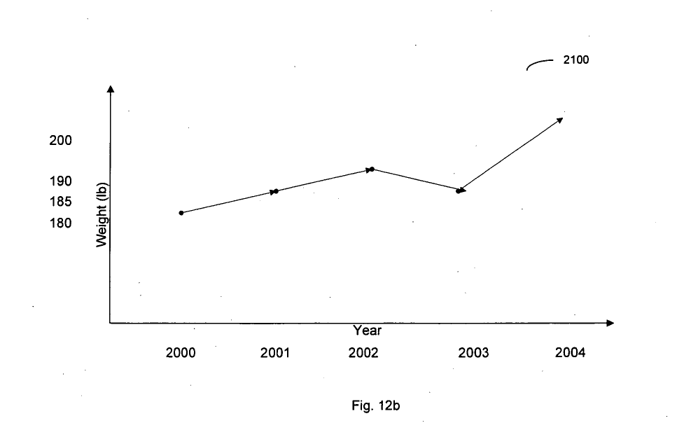

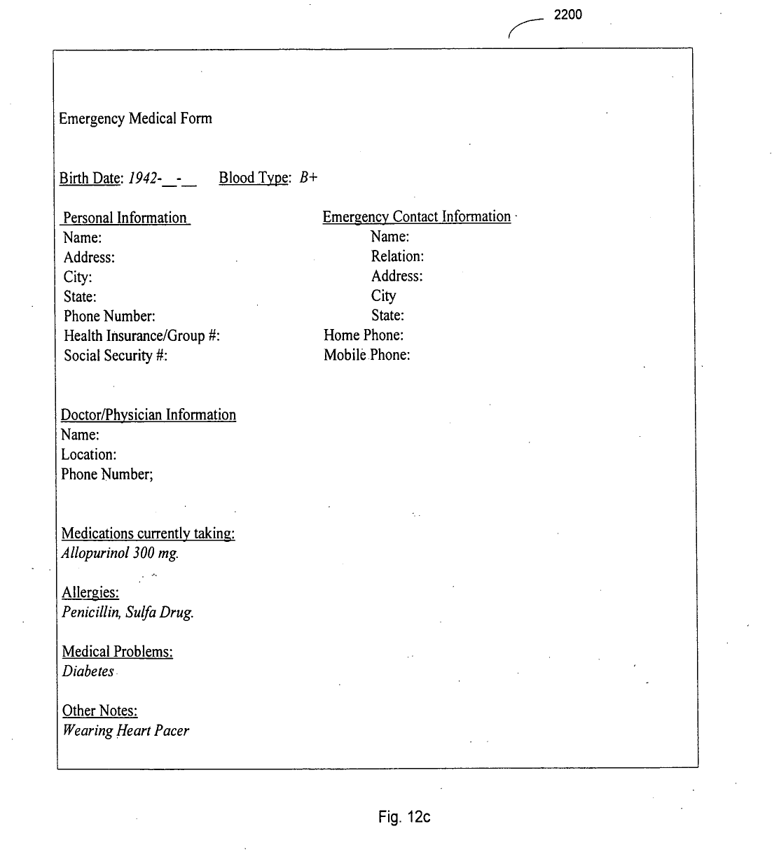

FIG. 12a shows a report that summarizes a relative's health history 2001, i.e., of the parents and/or siblings of a user. The figure as shown is a fragment of a full HTML report. Using this data, the user is provided the option of downloading the data into an XML file for Microsoft InfoPath, an RTF file for Microsoft Word or PDF file for Adobe Reader.

Another aspect of the present invention is the use and versatility of longitudinal data. That is, by using longitudinal data, histograms are plotted and an abrupt change in values indicates health problems. For example, if the weight of a person jumps suddenly by 50 lbs in a year, it indicates obesity or other health abnormalities. Such determinations are made by the knowledge base 214 using predefined rules and are applied against the longitudinal data.

FIG. 12b shows a histogram 2100 of the weight of a user over the last five years. As shown in FIG. 12b, a sudden increase in weight is noted in 2004. This weight gain triggers the rules in the knowledge base 214 to begin a health risk assessment on diabetes. In this way, the data analysis is proactive. This example of a histogram relates only to the weight of a user, but the application web site 104 is capable of providing this function using any longitudinal data.

FIG. 12c shows a partially filled emergency form 2200 that a user downloads from the application web site 104 in an HTML, XML, RTF, or PDF format. Even though the application web site 104 stores many data elements for a user, the user's identity is unknown. Hence not all the pertinent information usually contained in an emergency medical form is available to the application. However, the application web site 104 fills out as much as possible (shown in italics) and the user downloads the partially completed form and enters the remaining information locally. The personal identification information, i.e., name, address, social security number, health insurance carrier and plan id, is never sent to the application web site 104 so as to maintain anonymity. Using this data, the application web site 104 can accept any type of form provided by the user, whether customized or from an organization. To process these forms, the application web site 104 templates contain data field nametags in lieu of actual data values. The data field nametags in the templates must correspond to the data fields in the application web site 104. During a report generation, the user may request a partially or fully filled form based on any of the customized templates stored in the application's web site 104 template repertoire. When a report is created from a template, all the nametags in the template are replaced by actual values corresponding to the nametags.

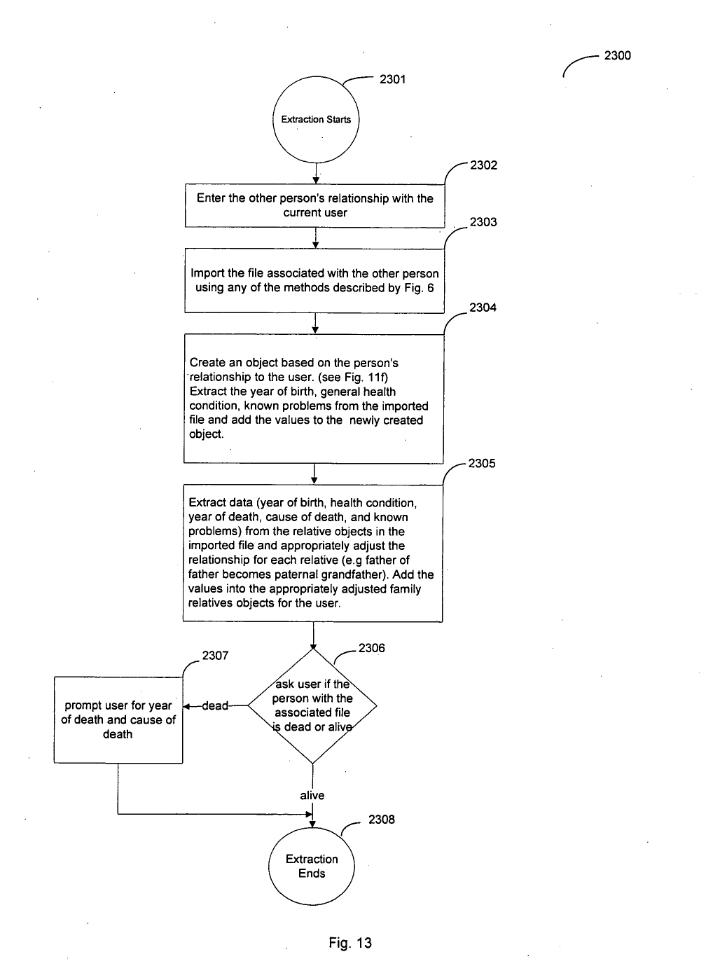

FIG. 13 describes a process 2300 for a user to extract data from a data file associated with the user's blood relatives. If a blood relative's own health data file exists for a particular user, a mechanism is provided to automatically extract health data from the relative's file and update the user's file. Process 2300 begins at step 2301. In step 2302, a user provides the application web site 104 a relationship with another person, e.g., father, mother, etc. For the purpose of this example, the blood relative used will be a father. In step 2303, the user imports the father's file by any of the methods described in FIG. 6. Next, the pertinent data from the imported file is added to the user's file. For example, fields such as the year of birth, the general health condition, and known problems for the father of the user are entered into the data fields, thus populating the user's object in step 2304. The father's object is then imported and the relationship is associated to the current user. In step 2305, the data is extracted and added to an appropriately adjusted family relative object. In step 2306, the user is asked if the person, i.e., father, is dead or alive. If the person is dead, in step 2307 the application web site 104 prompts the user for year and cause of death if this data does not exist. However, if the person is alive, the process is complete in step 2308 without further processing.

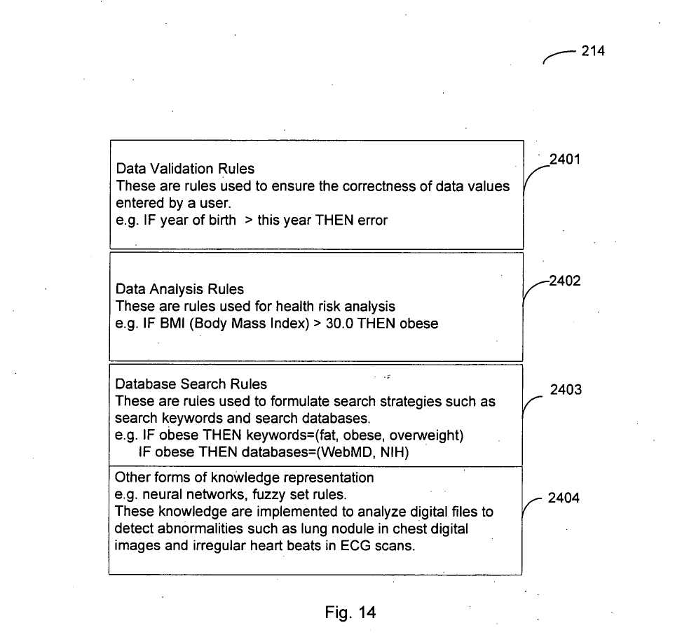

FIG. 14 shows one example of a structure of the knowledge base 214. The knowledge base contains data validation rules 2401, data analysis rules 2402, and database search 2403. For data validation 2401, the rules are triggered at time of data input. For example, the year of birth cannot be entered as a date in the future, i.e., IF year of birth>this year THEN error.

For data analysis 2402, the user's data is matched against the antecedents of all the rules in the knowledge base 214. For example, to determine if a person is overweight or obese, the following rules are tested:

IF BMI (body mass index)<18.5 THEN underweight

IF BMI >=18.5 AND BMI <25.0 THEN normal

IF BMI >=25.0 AND BMI <30.0 THEN overweight

IF BMI >=30.0 THEN obesity

Additional rules are contained in the knowledge base to run a database search.

For example, if it is determined that a person is obese, the rule engine may then apply additional rules. Specifically, by using the standard of “Forward Chaining” artificial intelligence, keywords for queries and database searches can be derived. An example of this is:

IF obesity THEN keywords=(“obese”, “overweight”, “fat”)

IF obesity THEN databases=(WebMD, about.com, NIH)

Finally, the knowledge base 214 also contains other forms of representation of knowledge 2404 that are suitable for digital data analysis. An example of this digital data analysis is a neural network which is used to detect lung nodules in chest digital images. Another example of digital data analysis is to use algorithmic methods and heuristic knowledge to filter noise out of ECG scans to detect irregularities in heartbeats.

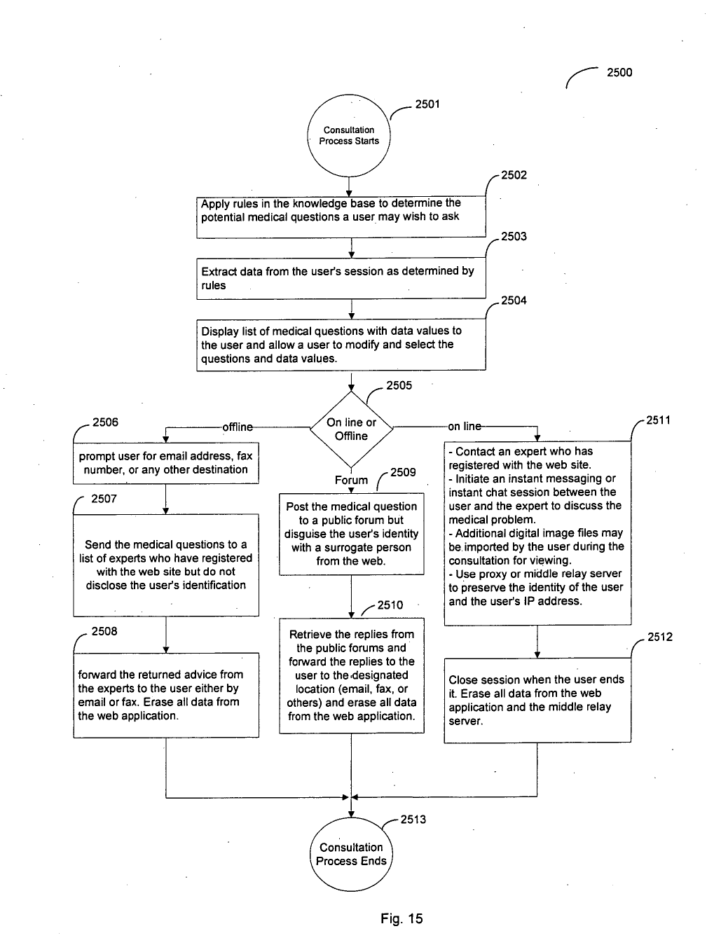

FIG. 15 illustrates the process 2500 of a user interacting with an expert. For the purpose of maintaining anonymity, the identity of the user is kept hidden in this process 2500. The process begins (step 2501) where the knowledge base 214 applies the appropriate rules (step 2502) to extract the user's data (step 2503). From the application of the rules, the user is presented with a list of medical questions (step 2504) that an expert is asked. For example, for an obesity consultation, the following question is presented: “A person of age 41, height 5′ 6″, and weight 300 lb seeks weight-loss diet to reduce calories-intake and fat-absorption.” The rules within the knowledge base 214 that deduce the medical question are as follows:

IF BMI >30.0 THEN obesity

IF obesity THEN reduce weight by diet consultation

IF reduce weight by diet consultation THEN provide age

IF reduce weight by diet consultation THEN provide weight

IF reduce weight by diet consultation THEN provide height

IF reduce weight by diet consultation TEHN reduce weight by diet

IF reduce weight by diet THEN reduce fat-absorption

IF reduce weight by diet THEN reduce calories-intake

A list of the generated questions along with the pertinent data is displayed to the user for editing and selection. After the user selects the questions, the user obtains an expert consultation from a panel of registered experts either off-line or on-line in step 2505. The user also requests that the application web site 104 post the questions on public forums using the application web site 104 as a surrogate.

If the user decides to use off-line consultation, the user is prompted for a communications means for the consultant to respond in step 2506. Next, in step 2507, the medical questions and data are posted to a panel of experts who have registered with the application web site 104 and whose identities will be disclosed to the user. During this communication, the experts are not aware of the user's identity unless the user explicitly discloses the identity to the experts. Next, in step 2508, the application web site 104 forwards the advice from the experts containing the experts' names and contact information to the user by email, fax, or other communications means provided in step 2506.

If the user decides to use on-line consultation, the application web site 104 initiates a consultation session either through instant messaging or private chat room mechanism as seen in step 2511. The application web site 104 acts as a proxy or middle relay server for the user so that the user's identity and IP address is protected. User messages are first transmitted to the middle server and then to the expert, and vice versa. The application web site 104 then displays the medical questions to the experts in the instant messaging box or private chat room. At this point, the user will be in direct contact with the expert(s). The instant messaging box or private chat room is closed in step 2512 when the user terminates the consultation.

Another method to talk to a consultant is to use a public forum. At the user's request, the application web site 104 posts the medical questions to a public forum. For security reasons, the application web site 104 in step 2509 acts as a surrogate to protect the true identity of the user. Further, the application web site 104 monitors the forums for a period of time and return any replies in step 2510 to the user periodically. In all cases, residual data is erased from the application web site 104 and middle server once a consultation session ends in step 2513.

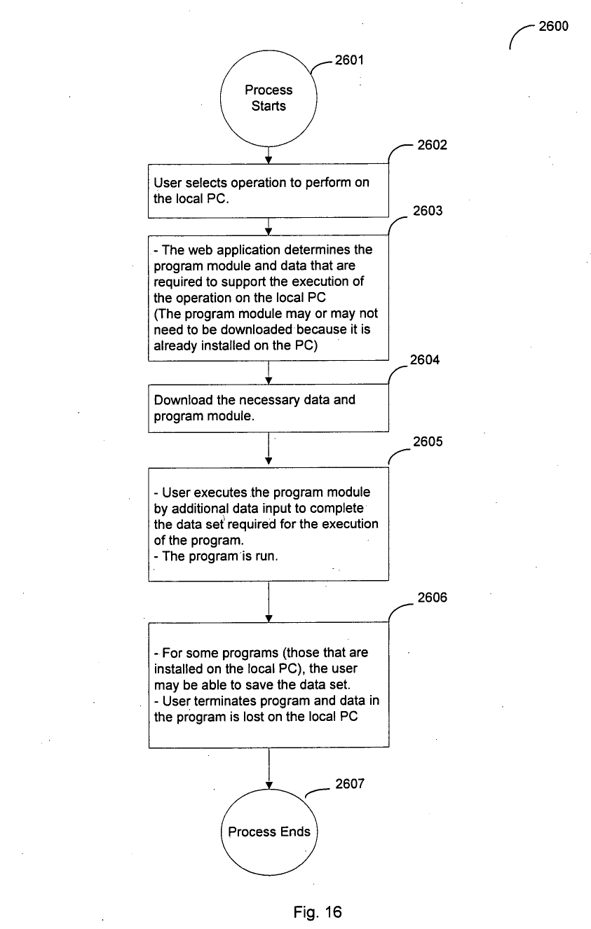

FIG. 16 shows the process 2600 by which the application web site 104 can initiate software programs on the local PC to capture personal identification data. During this process 2600, the personal identification data is never sent to the application web site 104 and hence privacy of personal identification data or other sensitive data is strictly maintained. Examples of the operations that are executed include the completion of partially filled emergency medical information sheet and health risk assessment based on sensitive data within software programs. These software programs are pre-installed on the local user PC (e.g., Microsoft Word) or downloaded on demand.

After initialization 2601, to process the data, the user in step 2602 selects an operation to perform on a local PC. The application web site 104 in step 2603 determines the type of program and the data that should be downloaded to the local PC in step 2604. For example, in the case of the partially filled emergency medical form, the program (assumed to be Microsoft Word if the user indicates a RTF format) is already installed on the PC and hence only a partially filled RTF file is downloaded. The application web site 104 next opens a new browser window and send a file of type “.rtf” to the newly opened browser. The browser, recognizing the “.rtf” file type, will invoke Microsoft Word automatically. After Microsoft Word opens, a user fills in the additional personal identification data in step 2605 and prints the file or saves the file to disk in step 2607. The user then terminates the operation by closing the Microsoft Word program. In the event that a program must be downloaded on demand, the application web site 104 opens a new browser window and downloads a Java Applet together with data. The user then inputs additional data to the applet and executes the applet at the local PC. After completing the execution of the applet, the user closes the browser and the applet causing the data to be erased from the PC's memory.

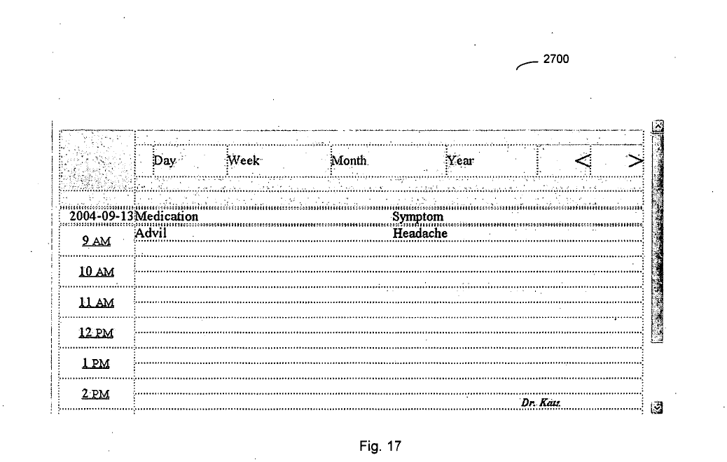

FIG. 17 shows a calendar feature 2700 of the present invention. This feature enables a user to keep a medical journal on a daily, weekly, monthly, or yearly basis. For the day calendar, each row indicates the events on the half hour. For example, in FIG. 17, the first row represents the events at 9:00 a.m., whereas the second row represents 9:30 a.m. To edit these times, a user left clicks a mouse on any row to indicate an insertion operation. The row is now in edit mode.

To further automation during the use of the calendar, a user simply starts typing or clicks on the “medication” button and a list of the current medications will be displayed. If the user adds a new medication, the medication will be recorded into the current medication list in the Clinical Information Form (see FIG. 11d) with the start date being today. In addition, the name and dosage of the medication is inserted into the row under modification in the calendar. Similarly, a symptom is typed into a row and the text will be automatically inserted into the health problems field on a Health Condition form.

The calendar is also capable of providing multiple views such as day, week, month or year. For example, when the weekly panel is selected, the item descriptions are summarized for that time frame. However, instead of tracking events on every half hour, the events will be described daily such as on Monday with headache and taking Advil. This calendar information is used to create reminders as described above. Within the display of the calendar, all future events are displayed with an italic font and all reminders are highlighted.

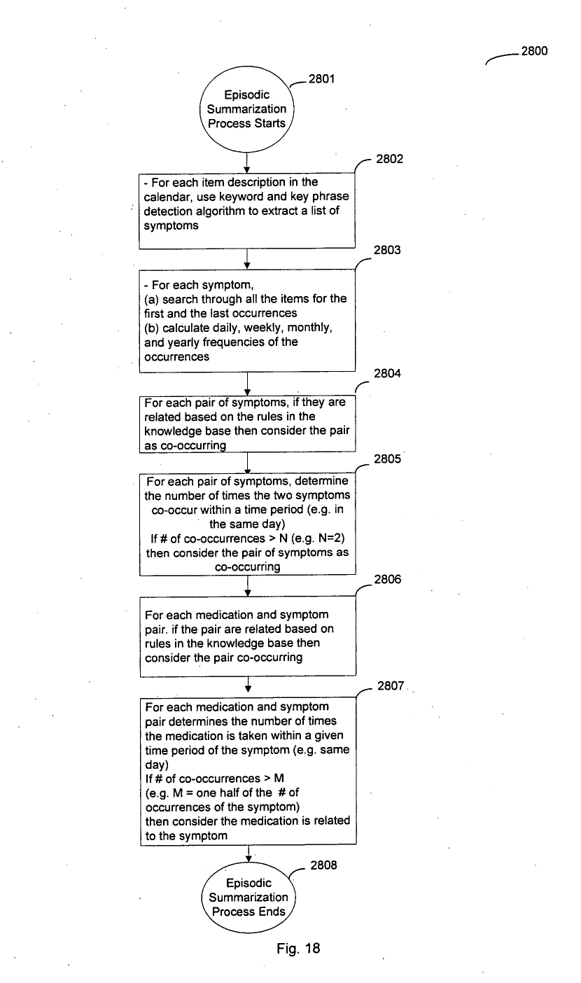

In another embodiment of the present invention, the application creates an episodic summary 2800 for the user, as seen in FIG. 18, for each medical symptom. Each episodic summary has the following information: (1) when did the symptom first occur, (2) what is the frequency of recurrences, (3) when did the symptom last occur, (4) what other symptoms co-occur with this symptom, and (5) what medications are taken for each occurrence. These episodic summaries are stored as episodic entries in the calendar as a textual description of a symptom, a medication, or an appointment. The textual descriptions are parsed by natural language techniques to extract a list of symptoms and a list of medications as seen in step 2802. To do this parsing, the application web site 104 contains a controlled vocabulary dictionary of symptoms and a controlled vocabulary dictionary of medications. Commercial medical dictionaries are also available, e.g., the Core Clinical Knowledge Base (CCKB) from Apelon. These dictionaries are used in conjunction with the knowledge base 214 on the application web site 104 to determine how symptoms are related to each other and what medications are appropriate.

To complete the process, the application looks up a word or phrase in the dictionary and, if found, this word or phrase is added to the list of symptoms or medications for further analysis. An example of a partial list of words or phrases is:

Ache—
Synonym: pain

Head Ache—

Stomach Ache—
Related: Abdomen Ache

Abdomen Ache—
Related: Stomach Ache

Joint Ache—
Related: Joint Swelling, Joint Inflammation

Dizziness—
Related: Faint, Fightheaded, Unconscious

NSAID—
Synonym: nonsteroidal anti-inflammatory drugs
Brands: Advil, Ibuprofen
Treats: Ache, Pain, Inflammation

For each symptom extracted in step 2803, all the descriptions in the calendar are searched to find the first mention and the last mention of the symptom in the calendar. Further, the frequencies of each symptom (daily, weekly, monthly, and yearly) are calculated based on the occurrence of a symptom in the calendar. In step 2804, for each pair of symptoms in the extracted list, the pair of symptoms is marked as co-occurring in the knowledge base 214. In addition, in step 2805 the knowledge base 214 determines how many times the two symptoms co-occur within a specific time period to find a trend. If the number of co-occurrences is high, i.e., greater than two, then the application web site 104 classifies the two symptoms as co-occurring in step 2805. For each symptom in the symptom list and each medication in the medication list, if the knowledge base 214 can associate the medicine as a known treatment of the symptom listed, then the medication becomes a co-occurrence as well in step 2806. Finally, in step 2807 the knowledge base 214 determines how many times a medication is taken within the same period as an occurrence of a symptom (e.g., same day). If the number of occurrences is high, i.e., the number is greater than a percentage of the occurrences of the symptom, then the knowledge base 214 considers the medication as a treatment of the symptom. Episodic summary process 2800 ends at step 2808.

### EQUIVALENTS

While this invention has been particularly shown and described with references to preferred embodiments thereof, it will be understood by those skilled in the art that various changes in form and details may be made therein without departing from the scope of the invention encompassed by the appended claims.

What is claimed is:

1. An electronic medical information system, comprising:
a server having a data storage area and a knowledge base;
a global network based application for temporarily storing one or more patient medical records anonymously in the data storage area, and for a given patient, the global network based application enabling the data storage area to effectively serve as a single location for accessing medical records of that patient;
the data storage area being accessible by a user in a secure manner; and
a server process using the data storage area in cooperation with the knowledge base to determine relevant medical history or advice for the user.

2. The electronic medical information system of claim 1, wherein the data storage area stores longitudinal data.

3. The electronic medical information system of claim 1, wherein the data storage area temporarily receives data by user upload or a third party site connection.

4. The electronic medical information system of claim 1, wherein the user is a person in the medical field and uses the server process for any of the following: to access the data storage area in such a way as to retrieve the medical records of one or more patients, to search the contents of the one or more patient medical records, to generate a report based on the one or more patient medical records, to download one or more patient medical records, or to enter data, manually, into the one or more patient medical records.

5. The electronic medical information system of claim 4, wherein the medical records of one or more patients includes any of the following: Hematology test results, Cardiac Risks test results, Lipid test results, Colorectal test results, Hormonal test results, Kidney test results, Liver test results, Men's Healthcheck test results, Minerals test results, Protein test results, Sugar levels test results, Thyroid test results, Urinalysis, Women's Healthcheck test results, x-rays, CT-scans, personal information, health metrics, health conditions, clinical information, laboratory test results, immunization, family history, other digital reports relating to medical treatment or miscellaneous medical data.

6. The electronic medical information system of claim 1, wherein the server process provides the user with the ability to analyze the data in the one or more patient medical records using the knowledge base.

7. The electronic medical information system of claim 1, wherein the user may import the one or more patient medical records of a relative so as to create a family medical history and the family medical history is accessible to the knowledge base for analysis.

8. The electronic medical information system of claim 1, wherein the knowledge base further validates data entered by the user, analyzes the one or more patient medical records for health risks, formulates search strategies to gather relevant information and/or analyzes digital files to detect abnormalities.

9. The electronic medical information system of claim 1, wherein the server process provides the user with consultation recommendations based on a set of rules within the knowledge base.

10. The electronic medical information system of claim 1, wherein the server process provides the user an ability to schedule one or more medical occurrences with a calendar for analysis and the server process allows the user to analyze the calendar for an episodic summarization.

11. The electronic medical information system of claim 1, wherein the user is a patient and uses the server process for accessing the data storage area in such a way as to retrieve the one or more of his medical records.

12. An method of using an electronic medical information system, comprising the steps of:
storing temporarily one or more patient medical records anonymously in a data storage area on a server for a given patient using a global network based application;
enabling the data storage area, using the global network based application, to effectively serve as a single location for accessing medical records of that patient;
accessing the data storage area by a user in a secure manner; and
determining relevant medical history or advice by a server process using the data storage area in cooperation with a knowledge base on the server.

13. The method of using an electronic medical information system of claim 12, further comprising the step of storing longitudinal data in the data storage area.

14. The method of using an electronic medical information system of claim 12, further comprising the step of sending data from the user upload or a third party site connection to the data storage area temporarily.

15. The method of using an electronic medical information system of claim 12, further comprising the steps of:
accessing the data storage area in such a way as to retrieve the medical records of one or more patients where the user is a person in the medical field using the server process; and
searching the contents of the medical records for one or more patients on the server for specific medical information and the user having the ability to generate a report based on the one or more patient records in the server.

16. The method of using an electronic medical information system of claim 12, further comprising the step of analyzing the data in the one or more patient medical records using the knowledge base.

17. The method of using an electronic medical information system of claim 12, further comprising the step of configuring the server process to provide the user with a reminder relating to the one or more patient medical records.

18. The method of using an electronic medical information system of claim 12, further comprising the step of importing the one or more patient medical records of a relative so as to create a family medical history and having the family medical history accessible to the knowledge base for analysis.

19. The method of using an electronic medical information system of claim 12, further comprising the steps of:
validating data entered by the user;
analyzing the one or more patient medical records for health risks;
formulating search strategies to gather relevant information; and
analyzing digital files to detect abnormalities.

20. The method of using an electronic medical information system of claim 12, further comprising the step of receiving consultation recommendations from the server process based on a set of rules within the knowledge base.

21. The method of using an electronic medical information system of claim 12, further comprising the steps of:
scheduling one or more medical occurrences using a calendar; and
analyzing the calendar to determine an episodic summarization.

22. The method of using an electronic medical information system of claim 12, further comprising the step of accessing the data storage area in such a way as to retrieve the medical records of one or more patient.
